(19) United States
(12) Patent Application Publication
(10) Pub. No.: US 2012/0137811 A1
(43) Pub. Date: Jun. 7, 2012

(54) Vehicle Having a Transmission and a Selection Element for Shifting Gears

(75) Inventors: Matthias Lindner, Graefelfing (DE); Thomas Tille, Muenchen (DE)

(73) Assignee: Bayerische Motoren Werke Aktiengesellschaft, Muenchen (DE)

(21) Appl. No.: 13/372,152

(22) Filed: Feb. 13, 2012

Related U.S. Application Data
(63) Continuation of application No. PCT/EP2010/005059, filed on Aug. 18, 2010.

(30) Foreign Application Priority Data
Sep. 22, 2009 (DE) 10 2009 042 524.1

(51) Int. Cl. G05G 5/03; F16H 59/04

(52) U.S. Cl. 74/473.11; 74/473.33; 74/473.12; 74/473.21

(57) ABSTRACT

A vehicle includes a transmission having at least one controllable actuator provided for engaging and/or disengaging at least one transmission gear, and a selection element to be operated manually, by which the actuator can be controlled, wherein. In order to engage a transmission gear, the selection element must first be moved in the direction of a specified end position assigned to the corresponding transmission gear. The selection element can be moved into the end position assigned to the corresponding transmission gear only when the corresponding transmission gear is actually engaged.

### CROSS-REFERENCE TO RELATED APPLICATIONS

This application is a continuation of PCT International Application No. PCT/EP2010/005059, filed Aug. 18, 2010, which claims priority under 35 U.S.C. §119 from German Patent Application No. DE 10 2009 042 524.1, filed Sep. 22, 2009, the entire disclosures of which are herein expressly incorporated by reference.

### BACKGROUND AND SUMMARY OF THE INVENTION

The present invention relates to a vehicle and, more particularly, to a vehicle having a transmission with at least one controllable actuator provided for engaging and/or disengaging at least one transmission gear, and a manually operable selection element by which the actuator can be controlled and thereby at least one transmission gear can be engaged or disengaged.

A vehicle of this type is known from German Patent document DE 198 49 076 A1.

In the case of vehicles having manual transmissions, the “gear shift lever” is usually coupled with the transmission by way of a mechanical connection, for example, by way of a linkage or a Bowden cable. In the passenger car sector, there are manual transmissions with up to 6 forward gears and one reverse gear, which are arranged in a so-called “H-shift pattern” with respect to the selector lever. Although manual transmissions exist in the truck sector that have up to 10 forward gears arranged in the H-shift pattern, 6 forward gears are considered to be the upper limit in the passenger car sector on the premise that the danger of faulty shiftings would rise considerably in the case of more than 6 forward gears arranged in an H-pattern.

In the case of manual transmissions in which the selector lever is mechanically coupled with the transmission, relatively long shifting travels occur at the selector lever, which requires a significant amount of installation space. A further disadvantage of selector levers mechanically coupled with the transmission is the fact that, for the “manual shifter” and automatic vehicle variants of one and the same vehicle type, different center consoles are required, which raises the manufacturing costs.

It is an object of the invention to provide a vehicle wherein a transmission can be controlled or shifted in a novel manner by way of a selection element.

This and other objects are achieved by a vehicle having a transmission with at least one controllable actuator provided for engaging and/or disengaging at least one transmission gear, and a manually operable selection element by which the actuator can be controlled and thereby at least one transmission gear can be engaged or disengaged. In order to engage a transmission gear, the selection element must first be moved in the direction of a specified end position assigned to the corresponding transmission gear. The selection element can be moved into the end position assigned to the corresponding transmission gear only when the corresponding transmission gear is actually engaged.

According to the invention, a vehicle is provided having a transmission with at least one controllable “actuator” provided for engaging and/or disengaging at least one transmission gear. The “actuator” may be an electrically or electronically, hydraulically, pneumatically or otherwise controllable actuating element by which one or more gears or shifting positions of the transmission can be shifted, i.e. can be engaged and/or disengaged. For controlling the at least one actuator, a manually operable “selection” element is provided which may, for example, have the shape of a selector lever. The actuator is controlled by operating the selection element, which actuator will then engage or disengage a gear or a transmission position. For engaging a transmission gear or a transmission position, the selection element first has to be moved in the direction of a specified end position assigned to the corresponding transmission gear or the corresponding transmission position. The operation for engaging a transmission gear or a transmission position is therefore initiated in that the selection element is moved in the direction of the corresponding end position without already reaching the end position. The selection element can be moved only into the end position assigned to the corresponding transmission gear or the corresponding transmission position if the corresponding transmission gear is actually already engaged.

As mentioned above, the selection element is preferably electrically or electronically connected with the actuator. Such a “shift-by-wire gear shift” makes it possible to construct the selection element in a very compact fashion, for example, in the shape of a small knob or the like, as known, for example, from modern selector levers in automatic vehicles.

According to a further development of the invention, the selection element or the selector lever is arranged on a “mechatronic element,” which generates control signals corresponding to the position of the selection element and permits a movement of the selection element into the end position assigned to a transmission gear only when the transmission gear is actually engaged.

A sensor system may be provided for this purpose which is electrically connected with the mechatronic element or is integrated in the mechatronic element. The sensor system senses the shifting condition of the corresponding transmission gear, i.e. whether the selected transmission gear has actually already been engaged by the assigned actuator or whether it is disengaged. When the corresponding “engaged signal” is present, the mechatronic element will free the end position; i.e. the selection element can only then be moved into the assigned end position by the driver.

According to a further development of the invention, the mechatronic element has a damping device which dampens or prevents movement of the selection element into the end position as long as the transmission gear assigned to the end position has not yet been engaged; i.e. as long as no corresponding engaged signal is generated by the sensor system.

It may be provided that the selection element engages in a haptically noticeable manner in the end position assigned to the corresponding transmission gear as soon as this end position has been reached.

Furthermore, a monitoring device may be provided for preventing faulty shifting attempts, particularly obvious faulty shifting attempts. Thus, the engaging of certain transmission gears can be prevented as a function of currently present driving condition parameters. It may, for example, be provided that, while the vehicle is standing, only the reverse gear, the first and perhaps also the second gear can be selected, but no higher forward gears. In addition, it may be provided that, during the drive, a shifting back is permitted only into those transmission gears in which the transmission cannot be damaged at the current vehicle speed.

The monitoring device can be constructed such that the mechatronic element or the “damping device” integrated therein completely blocks a movement of the selection element in the direction of a “blocked end position” or in the direction of a transmission gear blocked as a result of currently existing driving condition parameters; i.e. that the selection element cannot at all be moved into the corresponding “shift gate”. As an alternative, it may be provided that, although the selection element can be moved some distance in the direction of a currently blocked end position or some distance into a blocked shift gate, this does not result in the triggering of the concerned actuator and that, in particular, a reaching of the corresponding end position is blocked.

The primary field of application of the invention are vehicles having “manual transmissions”. The term “manual transmission” applies to a transmission that can only be shifted by operating the selection element from one transmission gear into another; i.e. not perhaps automatically shifted by a transmission control device.

Similar to conventional vehicles having manual transmissions, a separating clutch may be provided, which can be operated by a foot pedal and permits a soft shifting of the transmission. It may further be provided that it is monitored by use of a sensor system whether the clutch is opened or closed, and that an engagement or a disengagement of a transmission gear is permitted by triggering the assigned actuator only when the clutch has been completely opened.

However, in principle, the invention can also be used in connection with automatic transmissions, i.e. with transmissions which are controlled or shifted according to a specified switching logic by an electronic system as a function of different driving condition parameters, and furthermore, can additionally be shifted manually by way of a “shift-by-wire gearshift”.

It may further be provided that the presently engaged transmission gear is visually indicated, for example, in a display device, particularly in a so-called instrument cluster, arranged in the driver's visual range in front of the steering wheel. As an alternative or in addition, a display device may be provided on the selection element, particularly in an upper area of the selection element, by which the presently engaged transmission gear is visually indicated, for example, in an alpha-numerical or a symbolic fashion.

By means of the selection element, several gears, particularly more than the maximal number of 6 forward gears nowadays customary in the case of manual transmissions, can be shifted in a fault-free manner. One specified end position respectively of the selection element is assigned to each of the shiftable transmission gears. The end positions may be arranged in several mutually parallel shift gates corresponding to an H-shift pattern. Since, in contrast to the case of conventional manual transmissions, the selection element is not mechanically coupled with the transmission, one is not restricted to an H-shift pattern, but can arrange the end positions in a diversely different manner.

Summarizing, particularly the following advantages are achieved by means of the invention:

(a) potential of reducing consumption because more than 6 gears can also be meaningfully represented and easily controlled;

(b) short shifting travel and low shifting forces and thus high operating comfort;

(c) possibility of using one and the same center console for vehicles having a “manual transmission” as well as for vehicles having an “automatic transmission”;

(d) more ergonomic design possibilities with respect to the center console;

(e) reduction of noise level by using transmissions with 7 or more forward gears;

(f) less danger of shifting faults; and

(g) improvement of operating safety by display of gear position on the selection element.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is an exemplary schematic view of the basic principle of the invention; and

FIGS. 2 and 3 are embodiments of selection elements according to the invention.

### DETAILED DESCRIPTION OF THE DRAWINGS

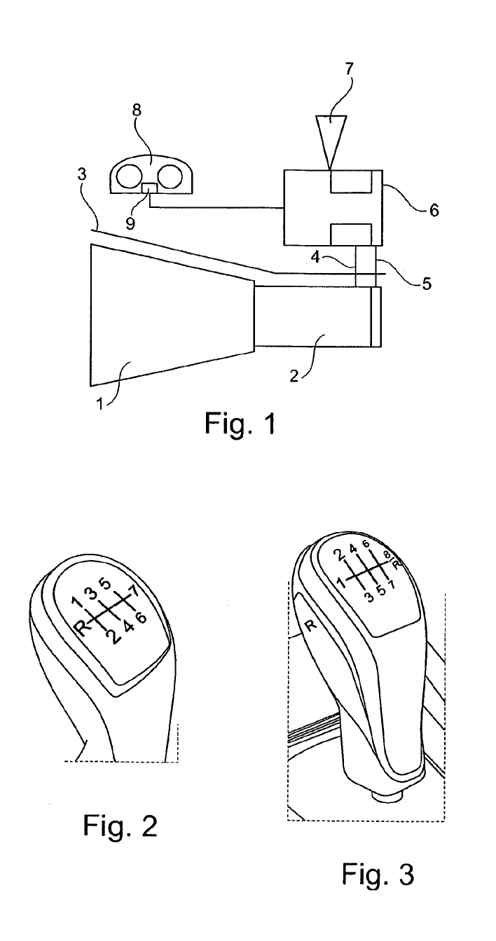

FIG. 1 illustrates a manual transmission 1 having an actuator module 2 in which several electrically or electronically controllable actuators are provided for engaging or disengaging transmission gears or gear positions. In addition, a sensor system not shown here in detail is integrated in the actuator module 2, which sensor system senses whether certain gears are engaged or disengaged. The transmission 1 and the actuator module 2 are arranged in a transmission tunnel, of which only the tunnel plate 3 is visible in the cross-sectional view of FIG. 1. The details of the above-described manual transmission are known to those of skill in the art and are not described further herein.

By way of electric lines 4, 5, the actuator module 2 is connected with a mechatronic element 6 which is arranged, for example, in a center console of the vehicle (not shown here in detail). A selection element 7 is arranged at the top side of the mechatronic element 6. The selection element 7 can be arranged at the mechatronic element 6, for example, in a swivelable, displaceable and/or rotatable or otherwise movable manner.

Various power drivers as well as a “shifting travel damper” may be integrated in the mechatronic element 6, which shifting travel damper dampens or prevents the movement of the selection element 7 in the direction of an end position assigned to a transmission gear or a transmission position, as long as the corresponding transmission gear or the corresponding transmission position has not yet been engaged. In other words, the selection element can be moved into the end position assigned to the corresponding transmission gear only when a corresponding signal that the corresponding transmission gear is actually engaged is present from the monitoring sensor system integrated in the actuator module.

For improving the operating safety, it may be provided that a display 9 is contained in an instrument cluster 8 that may be arranged in front of a vehicle steering wheel (not shown here in detail), in which display 9 the presently engaged transmission gear is shown.

FIG. 2 illustrates an embodiment of a selection element having seven forward gears and one reverse gear. In a conventional manner, the forward gear positions 1-6 are arranged in an H-pattern. The seventh forward gear is selected by a “swiveling-to-the-right” of the selection element. The reverse gear is selected by an opposite “swiveling-to-the-left” of the selection element.

FIG. 3 illustrates an embodiment of a selection element, where the forward gear positions 2-7 are arranged in an H-pattern. The first gear, which may only be a starting gear, is arranged on the left, and the reverse gear is arranged on the right with respect to the H-pattern.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle, comprising:
a transmission having at least one controllable actuator, said controllable actuator being provided for engaging and/or disengaging at least one transmission gear;
a manually operable selection element operatively configured for controlling the actuator to engage or disengage at least one transmission gear, the selection element requiring movement in a direction of a specified end position assigned to the corresponding transmission gear in order to engage the corresponding transmission gear; and
wherein the selection element is movable into the specified end position assigned to the corresponding transmission gear only when the corresponding transmission gear is actually engaged.

2. The vehicle according to claim 1, wherein the actuator is one of an electrically, hydraulically, and pneumatically, controllable actuator.

3. The vehicle according to claim 1, further comprising:
a mechatronic element at which the selection element is arranged, the mechatronic element being operatively configured to generate control signals corresponding to positions of the selection element and permitting a movement of the selection element into the specified end position assigned to the corresponding transmission gear only when the corresponding transmission gear is actually engaged.

4. The vehicle according to claim 2, further comprising:
a mechatronic element at which the selection element is arranged, the mechatronic element being operatively configured to generate control signals corresponding to positions of the selection element and permitting a movement of the selection element into the specified end position assigned to the corresponding transmission gear only when the corresponding transmission gear is actually engaged.

5. The vehicle according to claim 3, further comprising:
a sensor system electrically coupled with the mechatronic element, the sensor system being operatively configured to sense whether a selected transmission gear is actually engaged.

6. The vehicle according to claim 3, wherein the mechatronic element comprises a damper which dampens or prevents movement of the selection element into a respective end position as long as a transmission gear assigned to the respective end position has not yet been engaged.

7. The vehicle according to claim 5, wherein the mechatronic element comprises a damper which dampens or prevents movement of the selection element into a respective end position as long as a transmission gear assigned to the respective end position has not yet been engaged.

8. The vehicle according to claim 1, further comprising:
a haptic feedback device operatively coupled with the selection element, a haptic feedback being provided through the selection element in the end position assigned to the corresponding transmission gear as soon as said end position has been reached.

9. The vehicle according to claim 1, wherein the transmission is a manual transmission shiftable exclusively via operation of the selection element from one transmission gear into another transmission gear.

10. The vehicle according to claim 9, further comprising:
a clutch operable via a foot pedal in the vehicle, wherein engagement or disengagement of a transmission gear is permitted only when the clutch is opened.

11. The vehicle according to claim 1, wherein the transmission is an automatic transmission controlled according to a specified switching logic via an electronic system as a function of driving condition parameters.

12. The vehicle according to claim 1, wherein a presently engaged transmission gear is visually indicated in an instrument cluster arranged in a driver's viewing range in the vehicle.

13. The vehicle according to claim 1, further comprising:
a display device operatively arranged at the selection element, the display device providing a visual indication of the presently engaged transmission gear.

14. The vehicle according to claim 1, wherein several transmission gears are selectable via the selection element, in each case one specified end position of the selection element being assigned to one of the transmission gears, the end positions being arranged corresponding to an H-pattern in two or more parallel shift gates.

15. The vehicle according to claim 9, wherein several transmission gears are selectable via the selection element, in each case one specified end position of the selection element being assigned to one of the transmission gears, the end positions being arranged corresponding to an H-pattern in two or more parallel shift gates.

16. The vehicle according to claim 1, wherein, as a function of one or more currently present driving condition parameters, movement of the selection element in the direction of the end position is blockable.

17. The vehicle according to claim 1, wherein, as a function of one or more currently present driving conditions parameters, movement of the selection element into the end position and engagement of the corresponding transmission gear is blockable.

18. The vehicle according to claim 16, wherein one of the present driving condition parameters is vehicle speed.

19. The vehicle according to claim 17, wherein one of the present driving condition parameters is vehicle speed.
